(19) United States
(12) Patent Application Publication
(10) Pub. No.: US 2005/0253922 A1
(43) Pub. Date: Nov. 17, 2005

(54) Photolithography method and apparatus

(75) Inventor: Akihiro Hashiguchi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/118,771

(22) Filed: May 2, 2005

(30) Foreign Application Priority Data
Apr. 30, 2004 (JP) 135893/2004

(51) Int. Cl. B41J 2/435; H01J 33/00

(52) U.S. Cl. 347/229; 347/233

(57) ABSTRACT

In a photolithography method for performing photolithography with an exposing section that has a plurality of exposing head arrays arranged in the sub-scanning direction, cost reductions are achieved by extending the operation life of the exposing light sources and replacement cycles. Irradiation of the exposing light beams by the exposing head arrays is initiated or terminated on an array by array basis by drive controlling the exposing light sources constructed to output the exposing light beams, and if the irradiation coverage of an exposing head array is out of the photosensitive material, the laser modules are drive controlled such that the irradiation of the exposing light beams by the exposing head array is terminated.

### BACKGROUND OF THE INVENTION

1. Field of the Invention

The present invention relates to a photolithography method and apparatus in which a photosensitive material is exposed with an exposing section comprising a plurality of exposing head arrays arranged in the sub-scanning direction, each of which having a plurality of exposing heads disposed in the main scanning direction.

2. Description of the Related Art

Various types of photolithography machines are proposed, in which laser beams are modulated in accordance with image data using spatial light modulation devices, such as DMDs (digital micro-mirror devices) or the like, and a photosensitive material is exposed by the modulated laser beams.

One such photolithography machine in which a photosensitive material is exposed by scanning the material with a plurality of exposing heads having spatial light modulation devices is proposed as described, for example, in Japanese Unexamined Patent Publication No. 2001-338867. More specifically, a photolithography machine in which an exposure section comprising a plurality of exposing head arrays arranged in the sub-scanning direction, each of which having a plurality of aforementioned exposing heads disposed in the main scanning direction is proposed. In the machine, a photosensitive material is exposed by moving the exposing section in the sub-scanning direction relative to the photosensitive material.

Here, when photolithography is performed using the photolithography machine described above, the light beam emitted from a light source, such as a laser diode, is entered into the exposing head and irradiated on the photosensitive material after being modulated and focused by the exposing head. When photolithography is performed using the exposing section comprising a plurality of exposing head arrays arranged in the sub-scanning direction described above, however, the light beams irradiated from some of the exposing head arrays are out of the photosensitive material at the start and end of the photolithography. Consequently, the irradiation of the light beams from such exposing head arrays has conventionally been terminated by blocking the light beams from entering the exposing head arrays by mechanical shutters, or by controlling the DMDs on the exposing head arrays.

Even if the light beams irradiated from such exposing head arrays are terminated in the manner described above, unused light beams are still emitted from the light sources. This means a correspondingly longer operating time and shorter operation life of the light sources, resulting in shorter replacement cycle and higher cost. In particular, where the light sources are composed of a multitude of expensive laser diodes, the problem of cost increase becomes significant.

### SUMMARY OF THE INVENTION

The present invention has been developed in view of the circumstances described above, and it is an object of the present invention to achieve cost reductions in the photolithography method and apparatus, in which photolithography is performed with the exposing section comprising a plurality of exposing head arrays arranged in the sub-scanning direction, by extending the operation life of the exposing light sources and replacement cycles thereof.

A first photolithography method of the present invention is a method in which a photosensitive material is exposed by moving an exposing section in the sub-scanning direction relative to the photosensitive material, the exposing section comprising a plurality of exposing head arrays arranged in the sub-scanning direction in an indented manner in the main scanning direction, and each array having a plurality of exposing heads for irradiating exposing light beams by receiving the exposing light beams outputted from exposing light sources,
the method comprising the steps of:
drive controlling the exposing light sources constructed to output the exposing light beams to cause the exposing light beams to be outputted to each of the exposing head arrays on an array by array basis, and
initiating the exposure of the photosensitive material by the exposing head arrays on an array by array basis in the order in which the exposing head arrays are arranged in the sub-scanning direction.

A second photolithography method of the present invention is a method in which a photosensitive material is exposed by moving an exposing section in the sub-scanning direction relative to the photosensitive material, the exposing section comprising a plurality of exposing head arrays arranged in the sub-scanning direction in an indented manner in the main scanning direction, and each array having a plurality of exposing heads for irradiating exposing light beams by receiving the exposing light beams outputted from exposing light sources,
the method comprising the steps of:
drive controlling the exposing light sources constructed to output the exposing light beams to cause the exposing light beams outputted to each of the exposing head arrays to be terminated on an array by array basis, and
terminating the exposure of the photosensitive material by the exposing head arrays on an array by array basis in the order in which the exposing head arrays are arranged in the sub-scanning direction.

In the first and second photolithography method, the drive controlling of the exposing light sources constructed to output the exposing light may cause the exposing light beams to be outputted to the respective exposing heads on a head by head basis, and the exposing light beams may be irradiated only by a range of the exposing heads corresponding to the width of the photosensitive material in the main scanning direction.

Further, the exposing light beam outputted from the exposing light source may be detected, and the driving current of the exposing light source may be controlled based on the detected light intensity such that the detected light intensity becomes a predetermined value.

A first photolithography apparatus of the present invention is an apparatus, comprising:
an exposing section having a plurality of exposing head arrays arranged in the sub-scanning direction in an indented manner in the main scanning direction, each array having a plurality of exposing heads for irradiating exposing light beams by receiving the exposing light beams outputted from exposing light sources, and
a scanning means for exposing a photosensitive material with the exposing light beams by moving the exposing section in the sub-scanning direction relative to the photosensitive material, wherein
the exposing light sources are constructed to output the exposing light beams to each of the exposing head arrays on an array by array basis when drive controlled, and
the apparatus further comprises an exposing light source control means for controlling the exposing light sources such that the irradiation of the exposing light beams by the exposing head arrays is initiated on an array by array basis in the order in which the exposing head arrays are arranged in the sub-scanning direction for initiating the exposure of the photosensitive material.

A second photolithography apparatus of the present invention is an apparatus, comprising:
an exposing section having a plurality of exposing head arrays arranged in the sub-scanning direction in an indented manner in the main scanning direction, each array having a plurality of exposing heads for irradiating exposing light beams by receiving the exposing light beams outputted from exposing light sources, and
a scanning means for exposing a photosensitive material with the exposing light beams by moving the exposing section in the sub-scanning direction relative to the photosensitive material, wherein
the exposing light sources are constructed to terminate the exposing light beams outputted to each of the exposing head arrays on an array by array basis when drive controlled, and
the apparatus further comprises an exposing light source control means for controlling the exposing light sources such that the irradiation of the exposing light beams by the exposing head arrays is terminated on an array by array basis in the order in which the exposing head arrays are arranged in the sub-scanning direction for terminating the exposure of the photosensitive material.

In the first and second photolithography apparatuses of the present invention, the exposing light sources may be constructed to output the exposing light beams to the respective exposing heads on a head by head basis, and the exposing light source control means may be constructed to drive control the exposing light sources such that the exposing light beams are irradiated only by a range of the exposing heads corresponding to the width of the photosensitive material in the main scanning direction.

Further, the first and second photolithography apparatuses of the present invention may further comprise an exposing light beam detecting means for detecting the intensity of the exposing light beam outputted from the exposing light source, and a driving current control means for controlling the driving current of the exposing light source based on the detected light intensity such that the detected light intensity becomes a predetermined value.

According to the first and second photolithography methods and apparatuses of the present invention, the irradiation of the exposing light beams by the exposing head arrays is initiated or terminated on an array by array basis in the order in which the exposing head arrays are arranged in the sub-scanning direction at the start or end of the exposure of the photosensitive material by drive controlling the exposing light sources constructed to output the exposing light beams, so that the operation life of the exposing light sources may be extended by the time saved by avoiding the wasteful emissions, which allows longer replacement cycles of the exposing light sources by that much, and resulting in cost reductions.

Further, the first and second photolithography methods and apparatuses of the present invention may reduce the irradiation time of the exposing light beams on the mirror surfaces of the DMDs compared with the case in which the irradiation of the exposing light beams from the exposing head array is terminated by controlling the DMDs thereon, so that the mirror surfaces may be protected by that much, and the operation life of the DMDs may also be extended.

Still further, when the first and second photolithography methods and apparatuses of the present invention are adapted to irradiate the exposing light beams only by a range of exposing heads corresponding to the width of the photosensitive material in the main scanning direction by drive controlling the exposing light sources constructed to output the exposing light beams, and if, for example, the width of the photosensitive material in the main scanning direction is smaller that that of the exposing head arrays, wasteful operation of the exposing light sources corresponding to the range of the exposing heads which is out of the width of the photosensitive material in the main scanning direction may be avoided.

Further, where a laser diode or the like is used as the exposing light source, it does not provide a stable light intensity immediately after it is activated, and the irradiation of the exposing light beams needs to be held back until the light intensity is stabilized. If the first and second photolithography methods and apparatuses are adapted to detect the exposing light beam outputted from the exposing light source and to control the driving current of the exposing light source based on the detected light intensity such that the detected light intensity becomes a predetermined value, the wait time may be reduced and the operation time of the exposing light source may be reduced by that much, thus resulting in a longer operation life of the exposing light source.

### BRIEF DESCRIPTION OF THE DRAWINGS

FIG. 1 is a perspective view of a photolithography apparatus according to an embodiment of the present invention.

FIG. 2 is a perspective view of a scanner of the photolithography apparatus shown in FIG. 1, illustrating the structure thereof.

FIG. 3A is a plan view of a photosensitive material, illustrating the exposed areas thereof.

FIG. 3B is a drawing illustrating the disposition of the exposing area of each exposing head.

FIG. 3C is a drawing illustrating the adjacent stripe-like exposed regions partly overlapping with each other.

FIG. 4 is a perspective view of an exposing head, illustrating the overview thereof.

FIG. 5 is a partially enlarged view of a digital micro-mirror device (DMD), illustrating the construction thereof.

FIG. 6A is a drawing for explaining the operation of the DMD.

FIG. 6B is a drawing for explaining the operation of the DMD.

FIG. 7 is a perspective view of a fiber array light source, illustrating the construction thereof.

FIG. 8 is a block diagram of the photolithography apparatus shown in FIG. 1, illustrating the electrical construction thereof.

FIG. 9A is a drawing for explaining the operation of the photolithography apparatus shown in FIG. 1.

FIG. 9B is a drawing for explaining the operation of the photolithography apparatus shown in FIG. 1.

FIG. 9C is a drawing for explaining the operation of the photolithography apparatus shown in FIG. 1.

FIG. 9D is a drawing for explaining the operation of the photolithography apparatus shown in FIG. 1.

FIG. 10A is a drawing for explaining the operation of the photolithography apparatus shown in FIG. 1.

FIG. 10B is a drawing for explaining the operation of the photolithography apparatus shown in FIG. 1.

FIG. 11A is a drawing for explaining the operation of the conventional laser module.

FIG. 11B is a drawing for explaining the operation of the conventional laser module.

FIG. 12 is a drawing illustrating an optical system 67 of the exposing head shown in FIG. 4 according to another embodiment.

FIG. 13A is a drawing illustrating an embodiment of the driving method for the laser module of the photolithography apparatus shown in FIG. 1.

FIG. 13B is a drawing illustrating an embodiment of the driving method for the laser module of the photolithography apparatus shown in FIG. 1.

### DESCRIPTION OF THE PREFERRED EMBODIMENTS

Hereinafter, an embodiment of the photolithography apparatus upon which a photolithography method of the present invention may be implemented will be described with reference to the accompanying drawings. The photolithography apparatus of the present invention has advanced features in the drive controlling method for the exposing light sources. But, the overall construction of the apparatus will be described first to provide an overview of the apparatus.

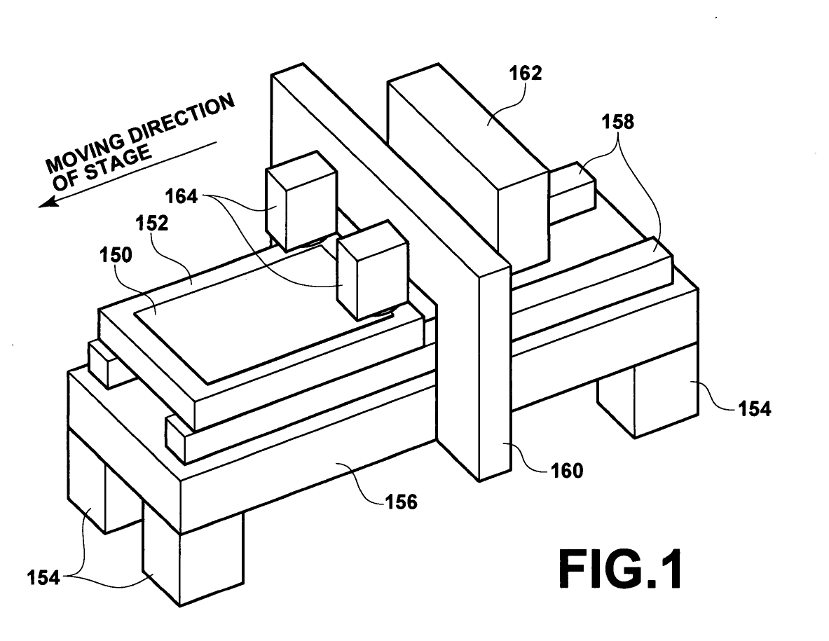

As shown in FIG. 1, the photolithography apparatus of the present embodiment has a plate-like moving stage 152 for holding a sheet-like photosensitive material 150 thereon by suction. Two guides 158 extending along the moving direction of the stage are provided on the upper surface of a thick plate-like mounting platform 156 which is supported by four legs 154. The stage 152 is arranged such that its longitudinal direction is oriented to the moving direction of the stage, and movably supported by the guides 158 to allow back-and-forth movements.

An inverse U-shaped gate 160 striding over the moving path of the stage 152 is provided at the central part of the mounting platform 156. A scanner 162, which is the exposing section, is provided on one side of the gate 160, and a plurality of sensors 164 (e.g. two) for detecting the front and rear edges of the photosensitive material 150 is provided on the other side. The scanner 162 and sensors 164 are fixedly attached to the gate 160 over the moving path of the stage 152. The scanner 162 and sensors 164 are connected to a controller (not shown) for controlling them.

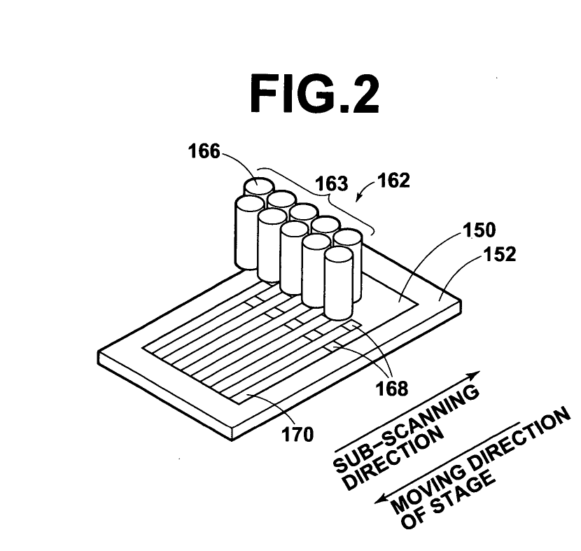

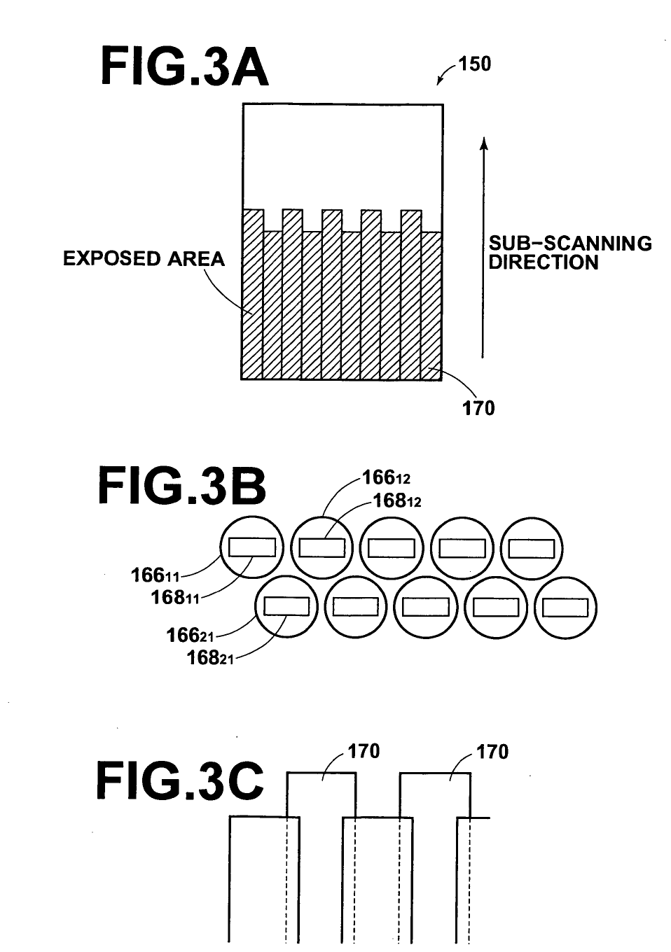

As shown in FIGS. 2 and 3B, the scanner 162 has a plurality of exposing head arrays 163, each comprising a plurality of exposing heads 166 disposed in the main scanning direction for irradiating the exposing light beams on the photosensitive material 150. The exposing head arrays are disposed in the sub-scanning direction in an indented manner in the main scanning direction. Hereinafter the exposing head disposed at the n^{th} column of the m^{th} array will be indicated as the exposing head 166ₘₙ.

The shape of an exposing area 168 of the exposing head 166 is rectangular with the short sides oriented in the sub-scanning direction. Accordingly, a stripe-shaped exposed region 170 is formed on the photosensitive material 150 by each exposing head as the stage 152 moves. Hereinafter, the exposing area of the exposing head disposed at the n^{th} column of the m^{th} array will be indicated as the exposing area 168ₘₙ.

As shown in FIGS. 3A and 3B, each of the linearly disposed exposing heads comprising the exposing head array 163 is disposed in the main scanning direction at a predetermined spacing (product of the long side of the exposing area multiplied by a natural number, which is 1 in the present embodiment) such that the stripe-like exposed regions 170 are formed side by side without any gap between them. Thus, the portion of the photosensitive material which may not be exposed by the exposing area 168₁₁ in the first array may be exposed by the exposing area 168₂₁ in the second array. Strictly speaking, the exposing heads in each of the exposing head arrays are disposed in the main scanning direction such that the adjacent stripe-like exposed regions partly overlap with each other as shown in FIG. 3C.

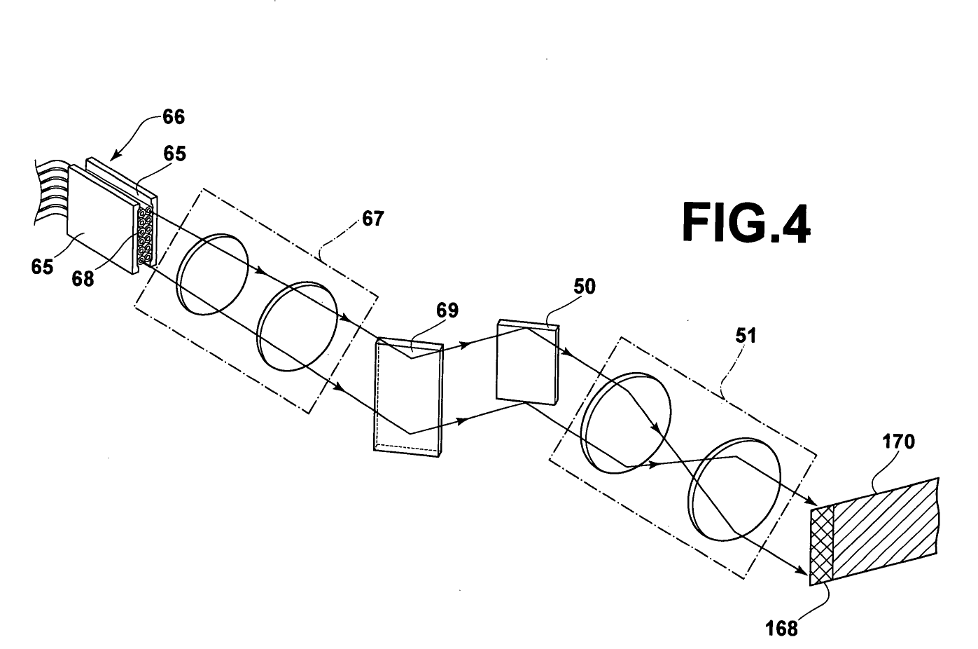

AS shown in FIG. 4, each of the exposing heads 166₁₁ to 166ₘₙ has a digital micro-mirror device (DMD) 50.

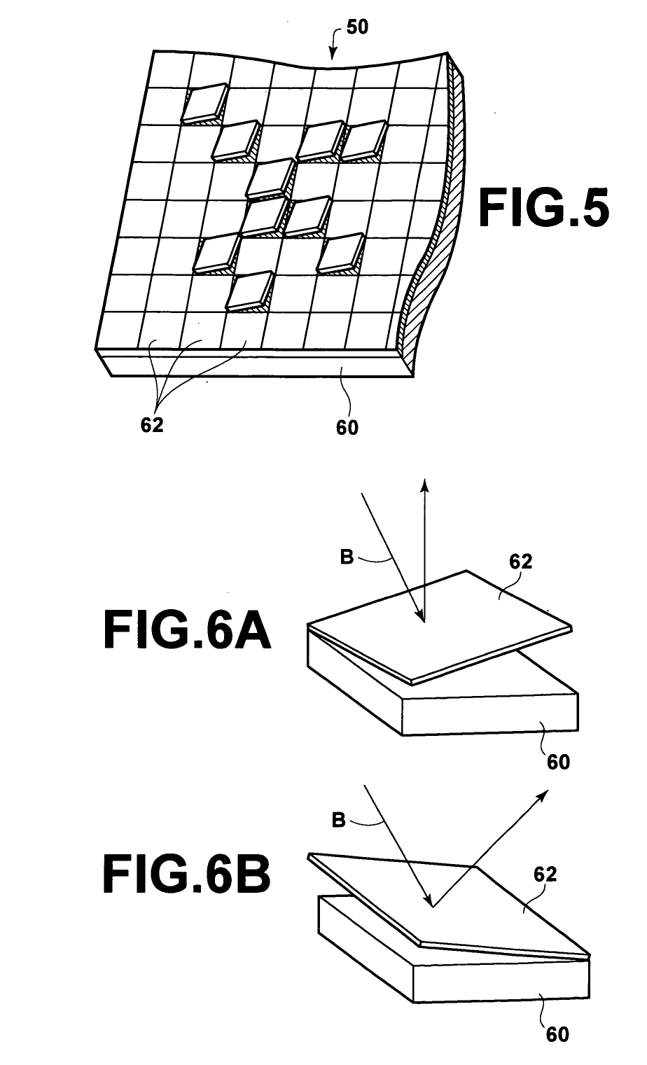

The DMD 50 has micro-mirrors 62 supported by support posts on SRAM cells (memory cells) 60 as shown in FIG. 5. It is a mirror device comprised of a multitude of micro-mirrors constituting pixels arranged in a lattice pattern (e.g., 1024×768). Each pixel has a micro-mirror 62 at the top supported by the support posts.

When digital data are written into the SRAM cell 60 of the DMD device 50, the micro-mirror 62 which is supported by the support posts is tilted within the range of ±α degrees (e.g., ±10 degrees) about the diagonal line against the substrate on which DMD 50 is placed. FIG. 6A shows a micro-mirror 62 tilted by +α degrees, which means that it is in on-state, and FIG. 6B shows the micro-mirror 62 tilted by −α degrees, which means that it is in off-state. Thus, by controlling the tilt angle of each micro-mirror in each pixel of the DMD 50 in accordance with image signals as shown in FIG. 6, the laser beams B incident on the DMD 50 are reflected to the tilted direction of each micro-mirror 62. The on/off control of the micro-mirrors is implemented by a controller 302 connected to the DMD 50, which will be described later.

Preferably, the DMD 50 is arranged in slightly inclined manner so that the short sides of the DMD 50 form a predetermined angle θ (e.g., 1 to 5 degrees) with the sub-scanning direction. Inclination of the DMD 50 in the manner as described above may provide a narrower pitch of the scanning trajectory (scanning line) of the exposing light beam of each micro-mirror compared with a non-inclined DMD 50, thus resulting in significantly improved resolution.

As shown in FIG. 4, a lens system 67 for condensing the laser beam outputted from a fiber array light source 66 and focusing it on the DMD, and a mirror 69 for reflecting the laser beam passed through the lens system 67 to the DMD 50 are disposed in this order on the light entering side of the DMD 50.

An imaging optics 51 for focusing an image on the photosensitive material 150 is disposed on the light reflected side of the DMD 50.

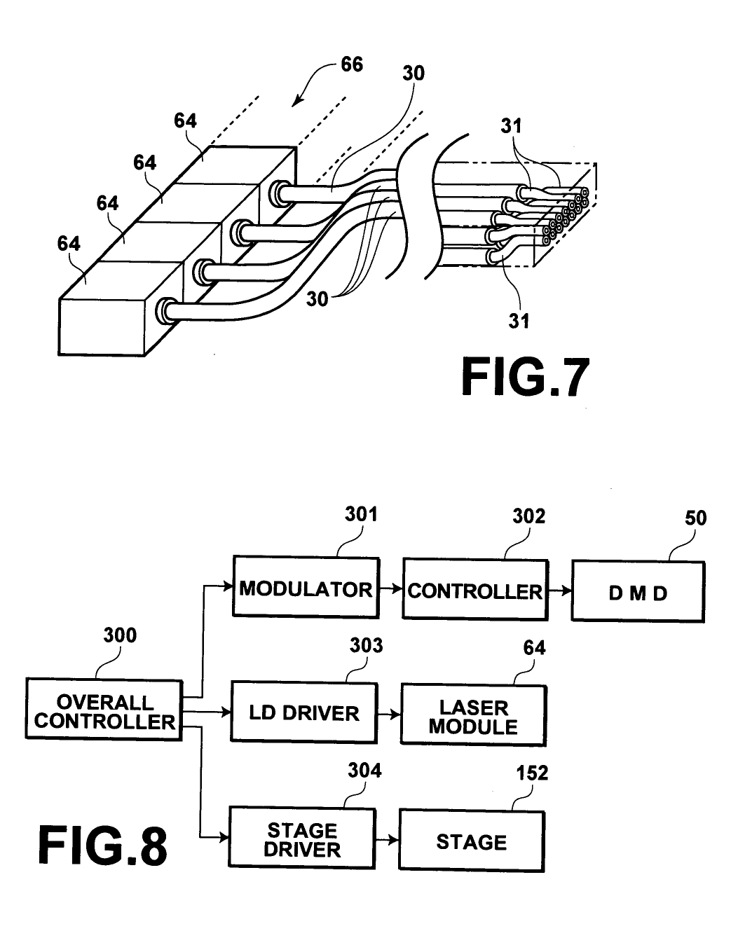

The fiber array light source 66 for outputting the laser beam to the exposing head comprises optical fibers arranged with the output edges (luminous points) being disposed linearly along the direction corresponding to the direction of the long sides of the exposing area 168. As shown in FIG. 7, the fiber array light source 66 has a plurality of laser modules 64 (e.g., 14 modules), and one end of a length of multi-mode optical fiber 30 is coupled to each laser module 64. A length of optical fiber 31 having the same core diameter and smaller clad diameter than the multi-mode optical fiber 30 is coupled to the other end of the multi-mode optical fiber 30. The fiber array light source 66 is provided for each exposing head 166, and the laser beams to each exposing head array 163 may be outputted or terminated on an array by array basis when drive controlled by LD drivers 303, which will be described later. In the present embodiment, the fiber array light source 66 is provided for each exposing head 166, but any construction may be employed for the light source as long as it is capable of outputting or terminating the laser beams to each exposing head array on an array by array basis.

Hereinafter, the electrical construction of the photolithography apparatus of the present embodiment will be described with reference to FIG. 8. As shown in FIG. 8, an overall controller 300 connects a modulator 301 that in turn connects a controller 302 for controlling the DMD 50. The overall controller 300 also connects an LD driver 303 for driving the laser module 64 of the fiber array light source 66, which is the exposing light source control means. The LD drivers 303 of the present embodiment drive control the fiber array light sources such that the laser beams outputted from an exposing head array is terminated if the coverage of the laser beams outputted from the exposing head array is out of the photosensitive material 150. Further, the overall controller 300 connects a stage driver 304 for driving the stage 152.

Hereinafter, the operation of the photolithography apparatus of the present invention will be described.

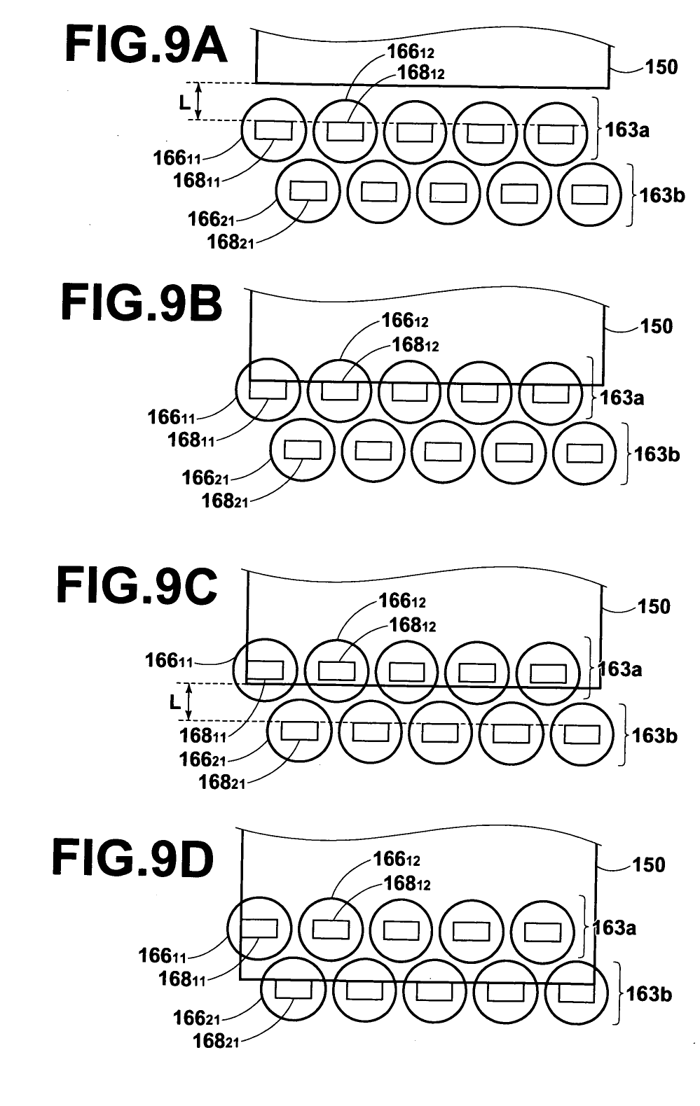

The stage 152 with a photosensitive material suctioned thereon is moved along the guides 158 at a constant speed from the upper stream to the down stream of the gate 160. When the stage 152 passes under the gate 160, the fore edge of the photosensitive material 150 is detected by the sensors 164 attached to the gate 160. In response to the detection of the fore edge of the photosensitive material 150, the laser modules 64 of the fiber array light sources 66 corresponding to the first array 163a of the exposing head arrays 163 (first laser module group) are drive controlled by the LD drivers 303, and laser beams are outputted from the first laser module group, which are entered into the exposing head array 163a to initiate the irradiation of the exposing light beams from the exposing head array 163a. The position of the first exposing head array 163a relative to the position of the photosensitive material 150 when the fore edge thereof is detected is set as shown in FIG. 9A. Preferably, the distance L shown in FIG. 9A is set based on the time required for the laser diode of the laser module for providing a stable light intensity, and moving speed of the stage 152.

When the position of the exposing head arrays 163 relative to the position of the photosensitive material 150 is as shown in FIG. 9A, the laser modules 64 of the fiber array light sources 66 corresponding to the second array 163b of the exposing head arrays 163 (second laser module group) are drive controlled by the LD drivers 303 such that no laser beam is outputted therefrom, and the irradiation of the exposing light beams from the exposing head array 163b is not started yet.

Then, the stage 152 is moved further and when the position of the exposing head array 163a relative to the position of the photosensitive material 150 is as shown in FIG. 9B, the exposure of the photosensitive material 150 is initiated by the exposing head array 163a. Thereafter, the stage 152 is moved still further and when the position of the exposing head array 163b relative to the position of the photosensitive material 150 is as shown in FIG. 9C, that is, the relative position of the exposing head array 163b is away from the fore edge of the photosensitive material by the distance L, the second laser module group is drive controlled by the LD drivers 303, and laser beams are outputted from the second laser module group, which are entered into the exposing head array 163b to initiate the irradiation of the exposing light beams from the exposing head array 163b. Then, the position of the exposing head array 163a relative to the position of the photosensitive material 150 is as shown in FIG. 9D, the exposure of the photosensitive material 150 is initiated by the exposing head array 163b.

In addition to inputting the laser beams to the exposing head arrays 163 in the manner as described above, image data stored in a frame memory are read out sequentially, and control signals based on the image data are outputted to each exposing head 166.

When a laser beam is inputted to the DMD50 of the exposing head 166 from the fiber array light source 66, the laser beam reflect by an on-state micro-mirror is focused on the photosensitive material 150 by the lens systems 54 and 58, while the laser beam reflect by an off-state micro-mirror is not focused on the photosensitive material 150. The laser beam outputted from the fiber array light source 66 is switched on and off on a pixel by pixel basis in the manner as described above, thereby the photosensitive material is exposed in a predetermined pattern.

Thereafter, the photosensitive material 150 is moved with the stage 152 at a constant speed, and the photosensitive material 150 is sub-scanned by the scanner 162 in the direction opposite to the moving direction of the stage, thereby a stripe-shaped exposed region 170 is formed by each exposing head 166.

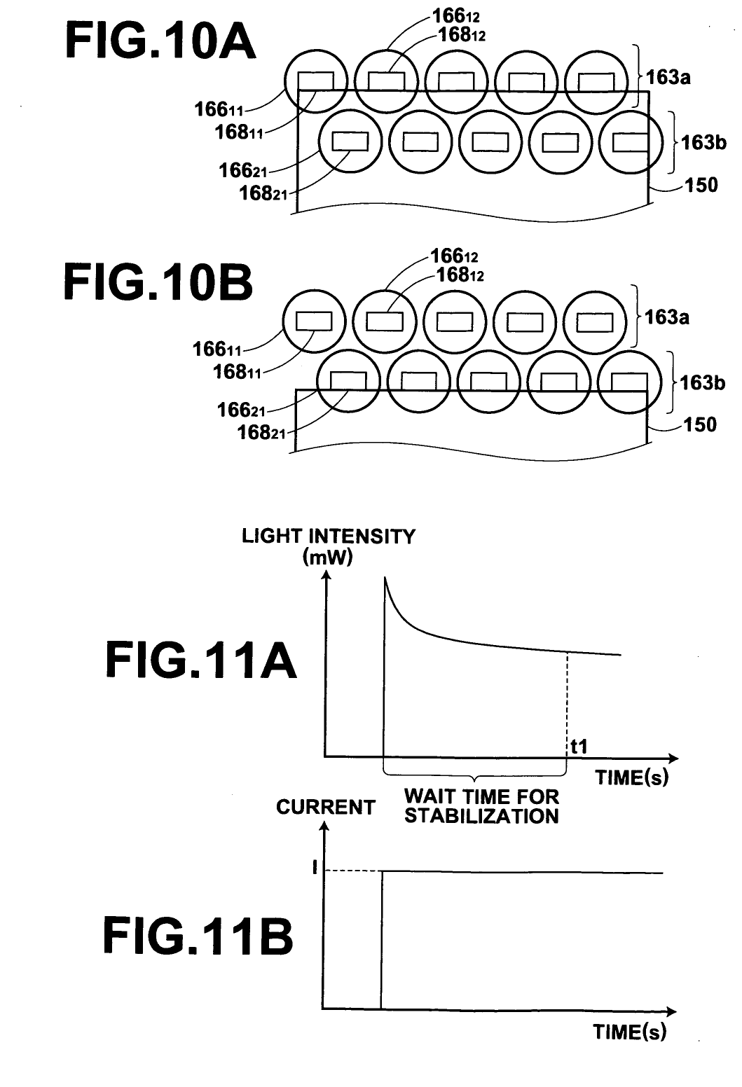

When the exposure of the photosensitive material 150 is coming to an end, the rear edge of the photosensitive material 150 is detected by the sensors 164. Position of the exposing head array 163a relative to the position of the photosensitive material 150 at that time is set as shown in FIG. 10A. When the rear edge of the photosensitive material 150 is detected by the sensors 164, the emission of the laser beams from the first laser module group is terminated by the drive-control of the LD drivers 303. The stage 152 is moved further, and when the position of the exposing heads 163b relative to the position of the photosensitive material 150 becomes as shown in FIG. 10B, the emission of the laser beams from the second laser module group is terminated by the drive-control of the LD drivers 303.

When the sub-scanning of the photosensitive material 150 by the scanner 162 is completed, the stage 152 is returned to the original position on the uppermost stream of the gate 160 along the guides 158. Thereafter, it is moved again along the guides 158 from the upper stream to down stream of the gate 160 at a constant speed.

According to the photolithography apparatus of the present embodiment, the first and second laser module groups are drive controlled to initiate or terminate the irradiation of the exposing light beams by the exposing head arrays on an array by array basis in the order in which they are arranged in the sub-scanning direction at the start or end of the exposure of a photosensitive material. This allows an extended operation life of the laser module 64 by the amount of time saved by avoiding wasteful emissions and longer replacement cycle of the module by that much, resulting in cost reductions.

For illustrating a specific example of cost reductions, it is assumed that the length of the exposing area of the photosensitive material 150 in the sub-scanning direction is 600 mm, moving speed of the stage 152 (or sub-scanning speed by the scanner) is 30 mm/s, and center-to-center distance of the exposing heads 166 is 120 mm. In this example, if the first and second laser module groups are simultaneously activated and terminated, the operation time of the laser module groups is, (600+120)/30=24 seconds, while if they are individually activated and terminated as in the photolithography apparatus of the present invention, the operation time is, 600/30=20 seconds, which is a 16.7% reduction of the operation time. If the length of the exposing area of the photosensitive material 150 in the sub-scanning direction is shorter, for example 300 mm, then the aforementioned calculations are, (300+120)/30=14 seconds, and 300/30=10 seconds respectively, resulting in more significant effect of operation time reduction of 28.6%. In addition, if a slower moving speed is used in order to improve the resolution in the sub-scanning direction, further effect of the operation time reduction may be obtained.

Where a plurality of laser modules, each having a plurality of laser diodes for emitting a plurality of laser beams which are combined into a length of multi-mode fiber through a condensing optics as described, for example, in Japanese Unexamined Patent Publication No. 2002-202442 is used, a large number of expensive laser diodes are required, so that the cost reduction effect becomes more significant.

In the photolithography apparatus of the present embodiment, the first and second laser module groups are drive controlled at the start and end of the exposure. But, the first and second laser module groups may be drive controlled either at the start or end of the photolithography in the manner as described above.

Further, in the photolithography apparatus of the present embodiment, the laser module 64 is used as the exposing light source. The laser diode of the laser module 64 does not provide a stable light intensity during a time period immediately after it is activated as shown in FIG. 10A, so that the irradiation of the exposing light beams needs to be held back until the time t1 for stabilizing the light intensity. Accordingly, the photolithography apparatus of the present embodiment may be constructed such that the exposing light beam outputted from the laser module 64 is detected, and the driving current of the laser module 64 is controlled based on the detected light intensity such that it becomes a predetermined value. This reduces the wait time described above so that the operation time of the exposing light source may be reduced by the reduced amount of time, resulting in an extended operation life of the exposing light source.

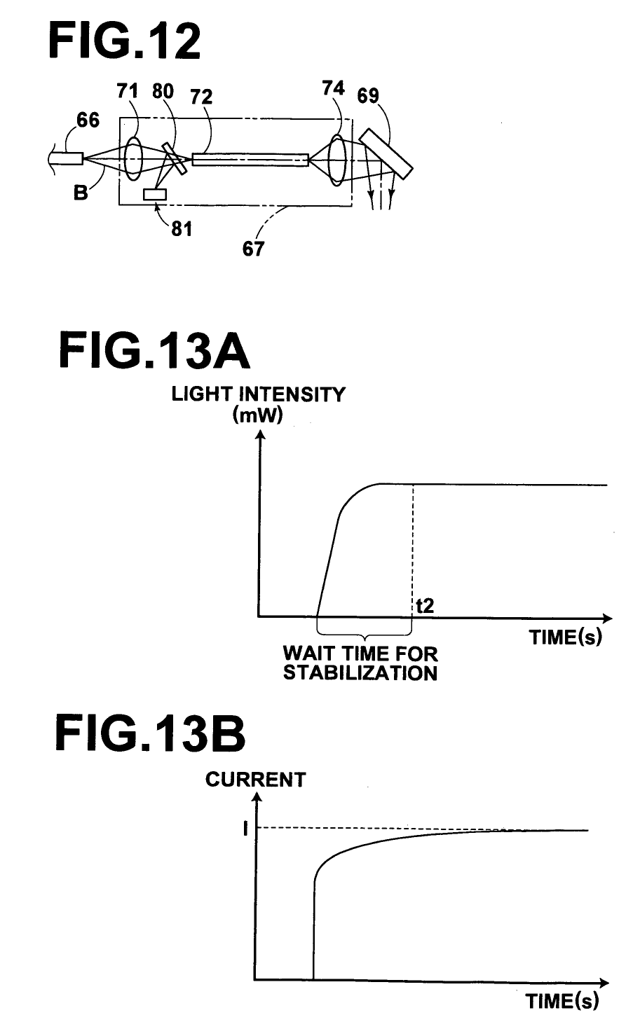

More specifically, an optical filter 80 for passing the light beam outputted from the fiber array light source 66 and passed through a condenser lens 71 and reflecting a part of the light beam, and an optical device 81 for detecting the light reflected by the optical filter 80 may be provided in a lens system 67 of the exposing head 166 as shown in FIG. 12. The intensity of the exposing light beam may be controlled by controlling the driving current of the laser module 64 through the LD driver 303 based on the magnitude of the electrical signal obtained by the photoelectric conversion within the optical device 81 such that the magnitude of the electrical signal becomes a predetermined value. For example, if the driving current is controlled such that the magnitude of the current is gradually increased to a predetermined value I as shown in FIG. 13B, the intensity of the light beam immediately after the activation of the laser module 64 may be stabilized more quickly as shown in FIG. 13A, so that the wait time may be reduced to the time t2. The illustrated optical system 67 comprises the condenser lens 71 for condensing the laser beam B outputted from the fiber array light source 66, a rod-shaped optical integrator 72 inserted in the light path of the light passed through the condenser lends 71, and an imaging lens 74 disposed in front of the rod-shaped optical integrator 72, that is, on the side of the mirror 69. The condenser lends 71, rod-shaped optical integrator 72, and imaging lens 74 are provided for entering the laser beam outputted from the fiber array light source on the DMD 50 as a substantially collimated beam with a uniform light intensity within the cross-section of the beam. In order to further reduce the wait time described above, a combiner module as described, for example, Japanese Patent Application No. 2003-083225 may preferably be used as the light source. More specifically, the combiner module is a light source in which a plurality of laser beams emitted from a plurality of laser diodes is collimated, and the collimated laser beams are combined in an optical fiber. If the beam diameter of the combined laser beam is approximately 1/2 of the fiber core, the combiner module light source may provide a rapid rise time of approximately one second, thus the wait time may be reduced to one second or less. In this way, the time required for stabilizing the light intensity just after the activation of the laser module is further reduced, and the operation time of the exposing light source may also be further reduced.

Still further, where the fiber array light source 66 is provided for each exposing head 166 as in the photolithography apparatus of the present embodiment, the fiber array light sources are drive controlled such that the exposing light beams are irradiated only by a range of the exposing heads corresponding to the width of the photosensitive material 150 in the main scanning direction. In this case, the width of the photosensitive material 150 in the main scanning direction may be inputted in advance through a predetermined inputting means, or it may be detected automatically by optical sensors.

1. A photolithography method in which a photosensitive material is exposed by moving an exposing section in the sub-scanning direction relative to the photosensitive material, the exposing section comprising a plurality of exposing head arrays arranged in the sub-scanning direction in an indented manner in the main scanning direction, and each array having a plurality of exposing heads for irradiating exposing light beams by receiving the exposing light beams outputted from exposing light sources,
the method comprising the steps of:
drive controlling the exposing light sources constructed to output the exposing light beams to cause the exposing light beams to be outputted to each of the exposing head arrays on an array by array basis, and
initiating the exposure of the photosensitive material by the exposing head arrays on an array by array basis in the order in which the exposing head arrays are arranged in the sub-scanning direction.

2. A photolithography method in which a photosensitive material is exposed by moving an exposing section in the sub-scanning direction relative to the photosensitive material, the exposing section comprising a plurality of exposing head arrays arranged in the sub-scanning direction in an indented manner in the main scanning direction, and each array having a plurality of exposing heads for irradiating exposing light beams by receiving the exposing light beams outputted from exposing light sources,
the method comprising the steps of:
drive controlling the exposing light sources constructed to output the exposing light beams to cause the exposing light beams outputted to each of the exposing head arrays to be terminated on an array by array basis, and
terminating the exposure of the photosensitive material by the exposing head arrays on an array by array basis in the order in which the exposing head arrays are arranged in the sub-scanning direction.

3. A photolithography method according to claim 1, wherein the step of drive controlling the exposing light sources constructed to output the exposing light beams causes the exposing light beams to be outputted to the respective exposing heads on a head by head basis, and the exposing light beams are irradiated only by a range of the exposing heads corresponding to the width of the photosensitive material in the main scanning direction.

4. A photolithography method according to claim 2, wherein the step of drive controlling the exposing light sources constructed to output the exposing light beams causes the exposing light beams to be outputted to the respective exposing heads on a head by head basis, and the exposing light beams are irradiated only by a range of the exposing heads corresponding to the width of the photosensitive material in the main scanning direction.

5. A photolithography method according to claim 1, further comprising the steps of:
detecting the exposing light beam outputted from the exposing light source, and
controlling the driving current of the exposing light source based on the detected light intensity such that the detected light intensity becomes a predetermined value.

6. A photolithography method according to claim 2, further comprising the steps of:
detecting the exposing light beam outputted from the exposing light source, and
controlling the driving current of the exposing light source based on the detected light intensity such that the detected light intensity becomes a predetermined value.

7. A photolithography apparatus, comprising:
an exposing section having a plurality of exposing head arrays arranged in the sub-scanning direction in an indented manner in the main scanning direction, each array having a plurality of exposing heads for irradiating exposing light beams by receiving the exposing light beams outputted from exposing light sources, and
a scanning means for exposing a photosensitive material with the exposing light beams by moving the exposing section in the sub-scanning direction relative to the photosensitive material, wherein
the exposing light sources are constructed to output the exposing light beams to each of the exposing head arrays on an array by array basis when drive controlled, and
the apparatus further comprises an exposing light source control means for controlling the exposing light sources such that the irradiation of the exposing light beams by the exposing head arrays is initiated on an array by array basis in the order in which the exposing head arrays are arranged in the sub-scanning direction for initiating the exposure of the photosensitive material.

8. A photolithography apparatus, comprising:
an exposing section having a plurality of exposing head arrays arranged in the sub-scanning direction in an indented manner in the main scanning direction, each array having a plurality of exposing heads for irradiating exposing light beams by receiving the exposing light beams outputted from exposing light sources, and
a scanning means for exposing a photosensitive material with the exposing light beams by moving the exposing section in the sub-scanning direction relative to the photosensitive material, wherein
the exposing light sources are constructed to terminate the exposing light beams outputted to each of the exposing head arrays on an array by array basis when drive controlled, and
the apparatus further comprises an exposing light source control means for controlling the exposing light sources such that the irradiation of the exposing light beams by the exposing head arrays is terminated on an array by array basis in the order in which the exposing head arrays are arranged in the sub-scanning direction for terminating the exposure of the photosensitive material.

9. A photolithography apparatus according to claim 7, wherein
the exposing light sources are constructed to output the exposing light beams to the respective exposing heads on a head by head basis, and
the exposing light source control means is constructed to drive control the exposing light sources such that the exposing light beams are irradiated only by a range of the exposing heads corresponding to the width of the photosensitive material in the main scanning direction.

10. A photolithography apparatus according to claim 8, wherein
the exposing light sources are constructed to output the exposing light beams to the respective exposing heads on a head by head basis, and
the exposing light source control means is constructed to drive control the exposing light sources such that the exposing light beams are irradiated only by a range of the exposing heads corresponding to the width of the photosensitive material in the main scanning direction.

11. A photolithography apparatus according to claim 7, further comprising:
an exposing light beam detecting means for detecting the intensity of the exposing light beam outputted from the exposing light source, and
a driving current control means for controlling the driving current of the exposing light source based on the detected light intensity such that the detected light intensity becomes a predetermined value.

12. A photolithography apparatus according to claim 8, further comprising:
an exposing light beam detecting means for detecting the intensity of the exposing light beam outputted from the exposing light source, and
a driving current control means for controlling the driving current of the exposing light source based on the detected light intensity such that the detected light intensity becomes a predetermined value.

13. A photolithography apparatus according to claim 7, wherein the exposing light source comprises a laser diode.

14. A photolithography apparatus according to claim 8, wherein the exposing light source comprises a laser diode.
